(19) United States
(12) Patent Application Publication
(10) Pub. No.: US 2010/0087936 A1
(43) Pub. Date: Apr. 8, 2010

(54) GOLF PERFORMANCE ASSESSMENT

(76) Inventor: John H. Roullier, Northwood (GB)

Correspondence Address: BRACEWELL & GIULIANI LLP, P.O. BOX 61389, HOUSTON, TX, 77208-1389, US

(21) Appl. No.: 12/499,227

(22) Filed: Jul. 8, 2009

(30) Foreign Application Priority Data
Oct. 3, 2008 (GB) 0818168.7

(51) Int. Cl. G06F 19/00

(52) U.S. Cl. 700/91; 473/409

(57) ABSTRACT

A system for assessing the performance of a golfer is disclosed. The system allocates a score to a particular shot based on the point from which the shot has been played, and the accessibility of the target from the point at which the ball has come to a halt. Allocated scores are then assembled and correlated, and may be recorded and/or analysed at a central database. They can be compared to reference figures as appropriate to provide an indication of the golfer's relative performance, and may take account of the golfer's handicap. The system can use wireless technology to enable performance material to be transmitted to a remote database from the golf course. The data generated can be useful both in analysis and as a teaching aid.

### RELATED APPLICATIONS

This patent application claims priority to United Kingdom Pat. App. No. 0818168.7 filed on Oct. 3, 2008, which is incorporated by reference in its entirety.

### BACKGROUND

This invention relates to the assessment of a golfers performance on a golf course. Various methods and devices for evaluating golfer's performance had been proposed, and reference is directed in this respect to U.S. Pat. No. 6,697,820, by way of example.

### SUMMARY OF THE INVENTION

The present invention is an assessment technique based on an approach different from those previously proposed, and particularly one which enables analysis of a golfer's performance to be focused on particular areas of his or her game, and to show trends in performance over periods of time.

According to the invention a method of assessing the performance of a golfer on a golf course comprises noting the origin of each shot; i.e. the point from which the shot is played, and allocating a score to each shot based on the accessibility of the target from the point of which the ball comes to a halt. Allocated scores are then assembled and correlated, and can be compared to reference figures as appropriate to provide an indication of the golfer's relative performance. The reference will normally be the regulation or par figure, but may be adjusted as appropriate according to the golfer's handicap.

To enable the consistent assessment of a golfer's performance according to the invention, it is preferred to adopt the following scoring system:

| | | Score | Notation |
|---|---|---|---|
| (a) | ball penalized by the Rules of Golf, eg | +2 | PP (penalty) |
| | played from outside teeing ground | | |
| (b) | ball penalized by the Rules of Golf, eg | +1 | P (penalty) |
| | in water requiring penalty drop | | |
| (c) | ball in poor position with little prospect of | +1 | B (bad) |
| | recovery of the shot lost | | |
| (d) | ball in poor position but prospect of recovery | +0.5 | W (weak) |
| | of the shot lost | | |
| (e) | ball in regulation position (par) | — | O (ordinary |
| | | | par) |
| (f) | recovery from c) or d) or set up for later | −0.5 | G (good) |
| | (f) shot to save complete shot | | |
| (g) | saves complete shot | −1 | E (excellent) |
| (h) | saves two complete shots | −2 | S (superb) |
| (i) | saves three complete shots | −3 | I (inspired) |

Every individual shot played in any round of Golf can be coded under this scoring system to show the total effect against the Par score for the round.

The circumstances leading to the position defined under a) and b) above will be readily recognized, as will a “regulation Par” shot as in e). Whether a poor position must be classified as c) or d) is of course a matter of judgment, but in practice I have found that a distinction can be usually be drawn between the two without difficulty. A badly misdirected drive, or missing a putt from within 2 yards for example would be classified under c). A shot into playable rough or a bunker, or a Chip Shot from under 50 yards to more than 5 yards from the hole, or a putt missed from 2 to 5 yards would be classified under d). The reason for allocating 0.5 to position d), is to enable the failure to be remedied as in f). For example, if the next shot played returns the player to a “regulation Par” position then the lost half point can be reclaimed. Examples would be a Weak drive on a Par 4 in the rough, followed by an approach shot on the green more than 5 yards from the hole. A Chip Shot to within a yard of the pin or a putt holing from 2 to 5 yards would also qualify. Situations in which one, two or three complete shots are saved will be readily understood, and the scores allocated to such shots correspond.

A particular benefit of the method of the invention is its ability to enable scores allocated for common shot types to be assembled separately. A particular shot type will depend upon the origin or point from which a shot is played. By keeping “shot types” records separately, a player can assess his or her performance in one or more particular aspects of the game with the method of the invention and identify areas of weakness. Shot types are typically defined as drives, approach shots, chips and putts. These definitions will apply to most circumstances, although other criteria can be used if appropriate.

A secondary notation can also be adopted in which Penalty, Bad and Weak shots are coded as Long (1), Right (2) Short (3) or Left (4), and in a Bunker(*). A Weak shot into a left bunker would therefore be coded W4*, giving information for future analysis to discover the reasons for the loss of shots and whether the errors are consistent.

The invention will be better understood from the following description of applications of the invention, and generation of players' assessments.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

FIG. 1 displays a data entry screen in accordance with an embodiment of the present invention.

FIG. 2 displays a help screen in accordance with an embodiment of the present invention.

### DETAILED DESCRIPTION

For recording purposes, each shot a player makes can be assessed according to a notation and each notation entered on the memory in a computer programmed to calculate the scores according to the notation. The notation will be related directly to the system summarized above, and will also classify the shots type enabling different points of play to be analyzed. Table I illustrates how the notation can be applied to an actual single round of golf. Although the final score is an excellent one under par 71, the table identifies an outstanding number of good approach shots compensated by weak putts indicating missed opportunities. This information can be retained and stored for future reference by the player or in a central commercial relational database or at club, association or professional level.

The scores allocated in a method according to the invention may of course be assembled from shots taken in many holes on a golf course, typically in a fall round or even in a number of rounds at the same or different courses. By keeping and accumulating scores allocated over a longer period and a large number of holes or courses played, a player can become aware of changes in his or her game. This is though, not only information useful for an individual player, but for golf analysts and coaches more generally when comparing past and ongoing performances by individual golfers.

In order to accumulate the scores of the kind made available in methods of the invention, the invention also provides a device for creating that record. The device comprises a receiver for entering a first value relating to the origin from which a different shot is played; a second value relating to the position of the ball when it comes to a halt and a third value relating to the distance of a ball from the target. The device can include a GPS unit for this purpose, or judgment can be used to assess these values. From these values a corresponding notation is established to generate the appropriate score, which is then entered in a memory. Alternatively a shot may be assessed and the respective notation entered directly on the device to generate the score. The scores can be compared to a reference figure as appropriate, but most importantly the device may retain the scores grouped in accordance with shot type, as discussed above. An individual record of this type will be useful for an individual golfer. For golf analysts, and Professional Golf Associations, records of these types for different golfers will be useful factors in determining the rank of the players in various tournaments and annual statistical records.

The device can include a transmitter for transmitting information on a round of golf to a central processor or control centre, for possible broadcasting presentations. The information for complete rounds, for professional and amateur golfers, may be transferred to a relational database, which can then be used as the source of material for many types of analysis. These may be comparisons; totals; percentages, graphs, or to establish trends or league tables. Alternatively the data can be recorded on a handwritten scorecard and transferred to the relational database through a Website.

The information generated can be of interest to Professional Golfing Associations. For example, a professional Tour could record and analyze say, 30,000 rounds a year and compare the information between players, and with that from other Tours, and/or from previous years. This could be of value to sponsors and the media. The information can also be used by individual and amateur golfers, assisted by their coaches, to study their own and others' performance and progress, and identify the areas in which improvement can be made.

The scoring system of the invention enables a golfer's performance to be assessed in percentage terms, and the performance of a number of golfers on the same course to be so assessed. This can be a useful guide to the difficulty of the course and/or the conditions under which it was played. Table 2 is an analysis of seventeen rounds of golf played against a par of 72 using the above notation. The round of Table 1 is analyzed as Player J.

Table 2 puts each shot played in one of the categories defined above. The right hand column lists the error percentage; ie, the loss of shots against Par, caused by the number of weak, difficult or penalty positions reached as a percentage of the final score. The bottom line indicates the average number of shots in each category within the seventeen rounds.

The significant variation in the number of weak and good shots achieved illustrates how the same or similar scores can be reached by steady or inconsistent play. An individual player's game can be monitored over successive rounds to determine whether he or she has a consistent variation of performance in this respect.

The notation system can be broken down to identify performance in each kind of shot; ie, identifying the origin or position from which the shot is played. Table 3 breaks down four rounds of golf in this way with each shot being allocated a score, and the total being given in the right hand column. The first round is that of Table 1.

As can be seen, Table 3 clearly indicates strengths and weaknesses. For example, round one shows two excellent and eleven good approach shots against thirteen weak putts in a round of 71, whereas round four illustrates a round of much greater consistency.

As noted above, details of and scores allocated to each shot played in one or a plurality of rounds of golf can be entered on a recording device for retention and/or onward transmission to a computer database. A suitable such device is described below.

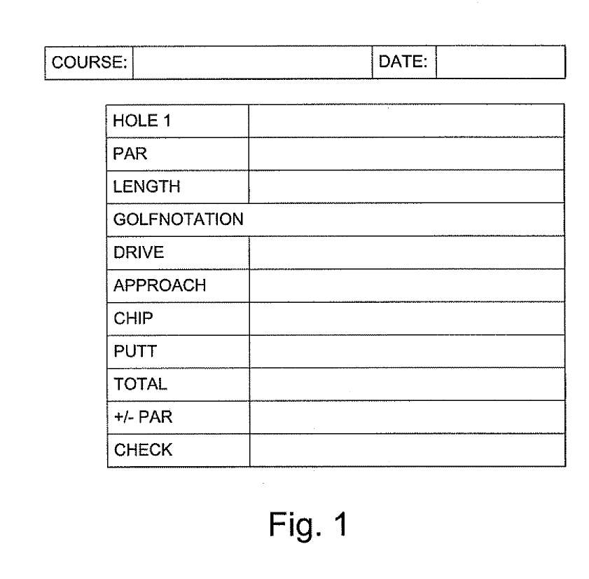

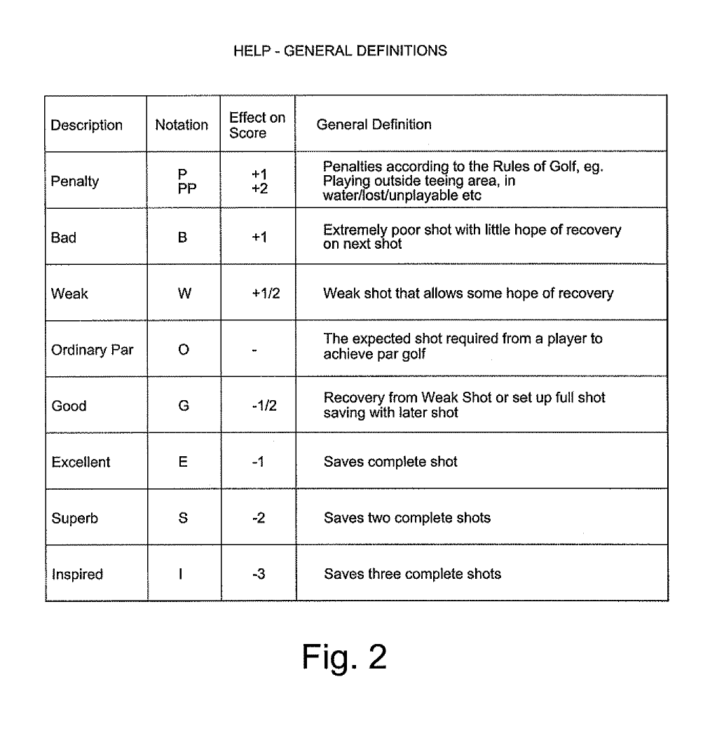

The device should have a screen to show the detail on FIG. 1. The Notation to be entered in each section will be as shown on the guide of FIG. 2, which will be supported by a Help Screen for each individual shot that can be played, eg for a Par 5 approach shot. Software in the device can convert the Notation into the total score for the hole and this will be compared with the exact score achieved. These two scores will be compared and the Check Digit ‘0’ will be shown in the last line (FIG. 1). If a difference is shown in the last column the notation must be checked and appropriate alteration made.

Individual golfers using the system regularly will quickly become used to recording their scores. In the case of Professional Golf Association Tournaments, the golfers would be made responsible for their scoring, and either they or their caddies will deal with the matter. The HELP SCREENS (FIG. 2) have been prepared to achieve the maximum simplicity, with access to be achieved to any particular shot currently being played. An understanding of the General Notation Definitions Sheet (FIG. 2) should quickly be obtained and the particular shot can therefore be quickly coded.

If a player has problems on a particular hole he should enter coding which adds to the total score against Par. Any small errors in recording would not have any effect on the overall volume of statistics collected.

For major tournaments it would be expected that 300 yard and probably 50 yard distance markers etc would be placed on the Course. However, judgment would be required for the 2, 5, 50 yard distances for chipping and putting. Training could be given to the Scorer on these distances, but yardage devices could be used, and it should not affect the Statistics if relatively small errors are made by some of the Scorers. Where appropriate, details of the respective course can be programmed into the recording device.

At the end of a round the data comprising the scores entered on the device can be transferred to a Relational Database. This will be achieved by accessing the User's Account at the Website—by user name or number and password, using a USB connection or by wireless transmission. The Relational Database computer can then analyze the data and an email report can be immediately sent to the golfer. A sample report is illustrated in Table 4 which shows a summary of the round scored in Table 1. It supports the earlier comments made on the analysis of this round of golf, and will be available on the Website, and on the recording device. It can be seen that this report confirms the analysis previously commented on regarding Player 1 in Table 3. The report will provide an immediate analysis of the round while it is still in the player's mind. Once the data is recorded and transmitted to the Computer Regional Database, further Reports can be prepared to show any analysis, comparison, total, trend, league table or percentage that is required.

For Professional Tournaments, equipment can be established with on line recording for the Recording Device to be plugged in as soon as the player finishes a round. The Press and other interested parties will then be able to access the Account to study the details from the available variety of Report Information. Course equipment could also be established to transfer data so that the Press could have information on uncompleted rounds during the day.

For amateur golfers, devices of the kind described above can be commercially available or provided at clubs and courses. A golfer can then use it on several rounds and have the data recorded and analyzed by the local Professional. The Professional can then draw attention to areas of the golfer's game where most shots are being lost, and concentrate his teaching on these areas. A professional golfer can also use the device in a similar way, in collaboration with his or her coach.

TABLE 1

| Hole | No. | Drive | Approach | Chip | Putt | Score | Notation |
|---|---|---|---|---|---|---|---|
| Par 3 | 3 | | G | | WO | 3 | |
| | 7 | | O | | 00 | 3 | |
| | 14 | | O | | WWO | 4 | +1 |
| | 16 | | G | | WO | 3 | |
| | | | 4 | | 9 | 13 | +1 |
| Par 4 | 1 | W | G | | WG | 4 | |
| | 2 | O | G | | WO | 4 | |
| | 4 | O | G | | WO | 4 | |
| | 6 | O | W | W | OO | 5 | +1 |
| | 8 | O | G | | WO | 4 | |
| | 11 | O | O | | OO | 4 | |
| | 12 | O | O | | WWO | 5 | +1 |
| | 13 | O | G | | WO | 4 | |
| | 15 | W | G | | E | 3 | −1 |
| | 18 | O | G | | WO | 4 | |
| | | 10 | 10 | 1 | 20 | 41 | +1 |
| Par 5 | 5 | O | G | W | WG | 5 | |
| | 9 | O | G | G | O | 4 | −1 |
| | 10 | O | E | | OO | 4 | −1 |
| | 17 | O | E | | OO | 4 | −1 |
| | | 4 | 4 | 2 | 7 | 17 | −3 |
| Total | | 14 | 18 | 3 | 36 | 71 | −1 |
| Shots | | | | | | | |

TABLE 2

| PLAYER | P | B | W | O | G | E | S | I | Shots | +/− Par | Error % |
|---|---|---|---|---|---|---|---|---|---|---|---|
| A | | | 5 | 44 | 13 | 3 | | | 65 | −7 | 3.8% |
| B | | | 5 | 47 | 11 | 3 | | | 66 | −6 | 3.8% |
| C | | 1 | 4 | 51 | 10 | 2 | | | 68 | −4 | 4.4% |
| D | | | 8 | 48 | 12 | 1 | | | 69 | −3 | 5.8% |
| E | | | 10 | 46 | 12 | 1 | | | 69 | −3 | 7.2% |
| F | | | 11 | 45 | 9 | 3 | | | 68 | −2 | 8.1% |
| G | | | 13 | 44 | 13 | 1 | | | 71 | −1 | 9.2% |
| H | | 4 | 7 | 48 | 7 | 5 | | | 71 | −1 | 10.6% |
| I | | 1 | 6 | 56 | 5 | 3 | | | 71 | −1 | 5.6% |
| J | | | 18 | 36 | 14 | 3 | | | 71 | −1 | 12.7% |
| K | | | 10 | 56 | 2 | 4 | | | 72 | — | 6.9% |
| L | | 2 | 14 | 41 | 12 | 3 | | | 72 | — | 12.5% |
| M | | 1 | 13 | 50 | 7 | 2 | | | 73 | +1 | 10.3% |
| N | | 1 | 16 | 41 | 14 | | | | 72 | +2 | 12.5% |
| O | 1 | 2 | 9 | 57 | 7 | | | | 76 | +4 | 9.9% |
| P | | 2 | 17 | 46 | 9 | 1 | | | 75 | +5 | 14.0% |
| Q | | | 23 | 46 | 7 | 1 | | | 77 | +7 | 14.9% |
| Average % | — | 1% | 15% | 67% | 14% | 3% | | | 100% | | |

TABLE 3

| | | B | W | O | G | E | S | I | | | |
|---|---|---|---|---|---|---|---|---|---|---|---|
| ROUND | P½ | +1 | +½ | 0 | −½ | −1 | −2 | −3 | SHOTS | +/−PAR | ERROR % |
| DRIVES | | | | | | | | | | | |
| 1 | | | 2 | 12 | | | | | 14 | +1.0 | 7.1% |
| 2 | | | 2 | 12 | | | | | 14 | +1.0 | 7.1% |
| 3 | | | 2 | 12 | | | | | 14 | +1.0 | 7.1% |
| 4 | | | 1 | 13 | | | | | 14 | −0.5 | 3.6% |
| | | | 7 | 49 | | | | | 56 | +3.5 | 6.2% |
| APPROACH SHOTS | | | | | | | | | | | |
| 1 | | | 1 | 4 | 11 | 2 | | | 18 | −7.0 | 2.8% |
| 2 | | 1 | 5 | 4 | 7 | 2 | | | 19 | −2.0 | 18.4% |
| 3 | | | 3 | 8 | 7 | | | | 18 | −2.0 | 8.3% |
| 4 | | | 1 | 12 | 5 | | | | 18 | −2.0 | 2.8% |
| | | 1 | 10 | 28 | 30 | 4 | | | 73 | −13.0 | 8.2% |
| CHIP SHOTS | | | | | | | | | | | |
| 1 | | | 2 | — | 1 | | | | 3 | +0.5 | 33.3% |
| 2 | | | | 4 | 5 | | | | 9 | −2.5 | — |
| 3 | | | 2 | 2 | 3 | | | | 7 | −0.5 | 14.3% |
| 4 | | | | 3 | 2 | | | | 5. | −1.0 | — |
| | | | 4 | 9 | 11 | | | | 24 | −3.5 | 8.3% |
| PUTTS | | | | | | | | | | | |
| 1 | | | 13 | 20 | 2 | 1 | | | 36 | +4.5 | 18.1% |
| 2 | | 1 | 7 | 21 | — | 1 | | | 30 | +3.5 | 15.0% |
| 3 | | | 3 | 23 | 2 | 2 | | | 30 | −1.5 | 5.0% |
| 4 | | | 6 | 20 | 5 | 1 | | | 32 | −0.5 | 9.4% |
| | | 1 | 29 | 84 | 9 | 5 | | | 128 | +6.0 | |
| TOTAL | | | | | | | | | | | |
| 1 | | | 18 | 36 | 14 | 3 | | | 71 | −1.0 | 12.7% |
| 2 | | 2 | 14 | 41 | 12 | 3 | | | 72 | — | 12.5% |
| 3 | | | 10 | 45 | 12 | 2 | | | 69 | −3.0 | 7.2% |
| 4 | | | 8 | 48 | 12 | 1 | | | 69 | −3.0 | 5.8% |
| | | 2 | 50 | 170 | 50 | 9 | | | 281 | −7.0 | 9.6% |

TABLE 4
Name Player J

| | |
|---|---|
| | Par |
| Shots | +/− |

| | | | |
|---|---|---|---|
| Drives | 14 | +1.0 | — |
| Approaches | 18 | +.05 | −7.5 |
| Chips | 3 | +1.0 | −0.5 |
| | 35 | +2.5 | −8.0 |
| Putts | | | |
| +5 Yards | 9 | +1.5 | −1.0 |
| 2-5 Yards | 12 | +5.0 | −1.0 |
| −2 Yards | 15 | — | — |
| | 36 | +6.5 | −2.0 |
| Total | 71 | +9.0 | +10.0 |
| +/− Par | −1 | | |

I claim:

1. A method of assessing the performance of a golfer on a golf course, comprising noting the origin of each shot and allocating a score to each shot based on the accessibility of the target from the point at which the ball comes to a halt; and assembling the allocated scores and comparing them to a reference figure.

2. A method according to claim 1 wherein the score allocated to each shot is calculated according to the following assessment:

| | | Score |
|---|---|---|
| (a) | ball penalized by the Rules of Golf | +2 |
| (b) | ball penalized by the Rules of Golf | +1 |
| (c) | ball in poor position with little prospect of | +1 |
| | recovery of the lost shot | |
| (d) | ball in poor position but prospect of | +0.5 |
| | recovery of the lost shot | |
| (e) | ball in regular position | 0 |
| (f) | recovery from (c) or (d), or set up for later | −0.5 |
| | (f) shot to save complete shot | |
| (g) | saves complete shot | −1 |
| (h) | saves two complete shots | −2 |
| (i) | saves three complete shots | −3 |

3. A method according to claim 1 wherein the scores allocated for common shot types are assembled separately.

4. A method according to claim 3 wherein the shot types are defined as drives, approach shots, chips and putts.

5. A method according to claim 1 wherein each shot is assessed according to a notation and each notation is entered on a memory in a computer programme to calculate scores according to the notation.

6. A method according to claim 1 wherein Penalty Bad and Weak shots are defined by a secondary notation as long, short, left or right, and whether they are in a bunker.

7. A method according to claim 5 wherein the scores allocated for common shot types are assembled separately, and wherein the computer is programmed to selectively accumulate scores achieved for individual shot types.

8. A method according to claim 1 wherein the golfer's handicap can be deducted from the total score achieved.

9. A method according to claim 1 wherein the allocated scores are assembled from shots taken in a full round of golf.

10. A method according to claim 1 wherein allocated scores are assembled from shots taken in a plurality of rounds of golf.

11. A method according to claim 1 wherein the rounds of golf are not all played on the same course.

12. A method of assessing the performance of a golfer, comprising assembling a record of each shot executed in each of a plurality of rounds of golf played, each record being allocated on the basis of the type of shot played, and the location of the point at which the ball comes to a halt according to the following criteria:

| | | Score |
|---|---|---|
| (a) | ball penalized by the Rules of Golf | +2 |
| (b) | ball penalized by the Rules of Golf | +1 |
| (c) | ball in poor position with little prospect of | +1 |
| | recovery of the lost shot | |
| (d) | ball in poor position but prospect of | +0.5 |
| | recovery of the lost shot | |
| (e) | ball in regular position | 0 |
| (f) | recovery from (c) or (d), or set up for later | −0.5 |
| | (f) shot to save complete shot | |
| (g) | saves complete shot | −1 |
| (h) | saves two complete shots | −2 |
| (i) | saves three complete shots | −3 |

collating scores allocated to common shot types in separate data stores, and noting the sum total of the scores in each store, the respective totals indicating the relative strengths of the golfer's play.

13. A method according to claim 12 wherein the shot types are selected from drives, approach shots, chips and putts.

14. A method according to claim 12 wherein the scores are entered on an electronic device and transferred to a computer database for subsequent access and analysis.

15. A method according to claim 14 wherein the electronic device has a wireless transmission facility, and the entered scores are immediately transmitted to the computer.

16. A method according to claim 15 wherein the electronic device is a mobile telephone with computing facilities.

17. A method according to claim 12 wherein the collated scores accumulated by a plurality of golfers are stored in a central database.

18. A device for assessing the performance of a golfer on a golf course in which each shot played is allocated a score on the basis of the accessibility of the target from the point at which the ball comes to a halt, which device comprises a receiver for entering a first value relating to the origin from which the shot was played; a second value relating to the lie of the ball; and a third value relating to the distance of the ball from the target; a comparator for correlating the three values to generate a said score; a memory for recording the allocated scores for each shot played; and a comparator for comparing the allocated scores to one or more reference figures.

19. A device according to claim 18 including an analyser for accumulating scores in shots from common origins to assess the golfer's performance with such shots.

20. A device according to claim 18 including an accessible memory for storing accumulated scores from different golf courses.

21. A system for use in assessing the performance of a golfer, comprising an electronic device for receiving records of shots played, each record being allocated on the basis of the type of shot played and the location of the point at which the ball comes to a halt according to predetermined criteria; a computer having a memory for storing scores received by the device, the computer being programmed to collate scores allocated to common shot types in separate data stores in the memory and generate sum totals of the scores in each store, for each round and each golfer and having an output for displaying records from the data stores, and comparing rounds played.

22. A system according to claim 21 wherein the electronic device includes a wireless transmitter for transmitting said scores to a remote said computer.

23. A system according to claim 22 wherein the electronic device is a mobile telephone with computing facilities.
